(19) United States
(12) Patent Application Publication
(10) Pub. No.: US 2005/0252674 A1
(43) Pub. Date: Nov. 17, 2005

(54) Electrical junction

(76) Inventor: Bruno Lanbach, Mils (AT)

Correspondence Address: WENDEROTH, LIND & PONACK, L.L.P., 2033 K STREET N. W., SUITE 800, WASHINGTON, DC, 20006-1021, US

(21) Appl. No.: 11/129,405

(22) Filed: May 16, 2005

(30) Foreign Application Priority Data
May 17, 2004 (AT) A 865/2004

(51) Int. Cl. H02G 3/06

(52) U.S. Cl. 174/84 C; 174/88 R

(57) ABSTRACT

An electrical junction having at least three electrical conductors which project in different directions from at least one connecting point, with, in the region of the connecting point (2), the conductors (1) being surrounded with insulating material (4), with the conductor ends (1a) projecting out of the insulating material (4).

The invention relates to an electrical junction having at least three electrical conductors which project in different directions from at least one connecting point.

When conductors are to be connected in a T shape or Y shape (or, in general terms, also a star shape), the problem arises of protecting the region of the connecting point from environmental influences, in particular moisture. Whereas it is a simple matter to seal a connecting point for only two conductors using a shrink-on tube, if there are more than two conductors, and in particular in the case of a branch point in a T shape or Y shape, this has not been possible hitherto using standardised shrink-on tubes, because of the geometric conditions.

To solve this problem, the invention proposes an electrical junction having at least three electrical conductors which project in different directions from at least one connecting point and which is characterised in that, in the region of the connecting point, the conductors are surrounded with insulating material, with the conductor ends projecting out of the insulating material. In the case of an electrical junction of this kind, the conductors are thus beforehand surrounded in sealing manner on all sides by insulating material, for example a curable synthetic composition, by injection moulding or encapsulation in the region of the critical connecting point (for example a T branch or a Y branch). For this, the injection moulding process is particularly suitable. The conductor ends project beyond the insulating material of the electrical junction in exposed manner, that is to say with no insulation, and thus enable further (in particular, flexible) electrical conductors or cables to be attached. This attaching can be carried out on site. The advantage of the invention consists in the fact that the critical connecting point, for example a T-shaped or Y-shaped connecting point, is already encapsulated in sealing manner beforehand, and that on site only the further conductors or cables still have to be attached to the prefabricated electrical junction. These individual attachment points can be sealed relatively easily, for example using shrink-fit connectors which are known per se. The shrink-on tube used in this case shrinks under the action of heat and comes up in sealing manner against the outer insulation of the attached cable, on the one hand, and in sealing manner against the insulating material of the electrical junction according to the invention, on the other.

Further advantages and details of the invention are explained in more detail with reference to the description of the figures which follows.

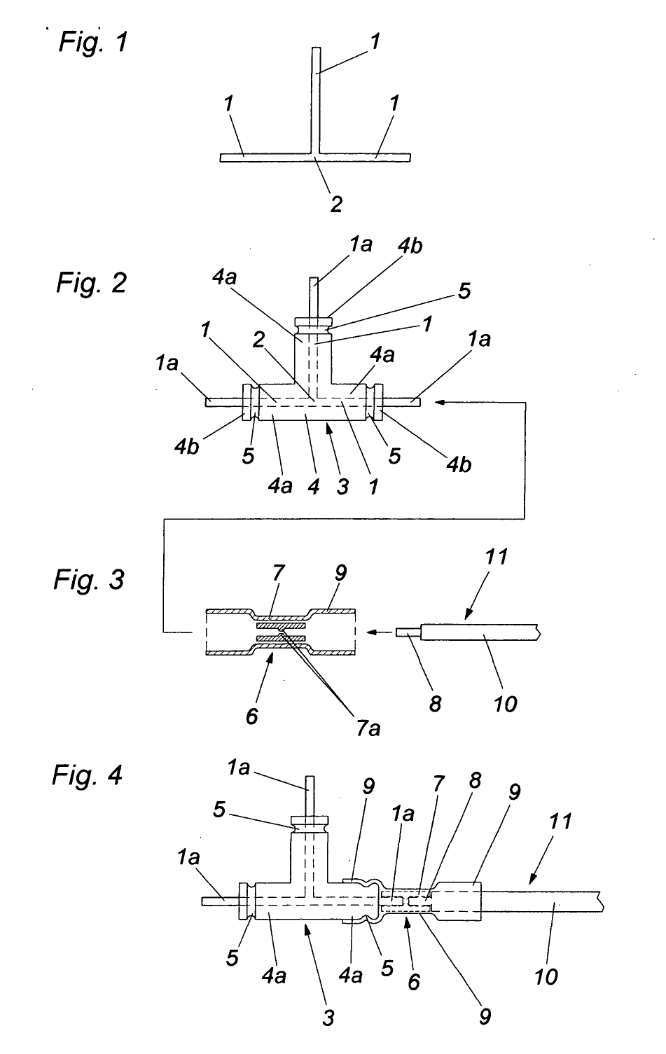

FIG. 1 shows three electrical conductors connected to one another in a T shape.

FIG. 2 shows an example embodiment of an electrical junction in side view.

FIG. 3 shows a shrink-fit connector, known per se, in a diagrammatic longitudinal section, and one end of a further flexible electrical conductor or cable which is to be connected.

FIG. 4 shows an example embodiment of the electrical connection system with an electrical junction and a further cable which is attached by way a shrink-fit connector.

In FIG. 1, three electrical conductors 1, in particular rigid wires, are connected to one another in a T shape at a connecting point 2.

In accordance with the invention, the conductor arrangement in accordance with FIG. 1 is now surrounded on all sides by an insulating material in the region of the connecting point 2. In particular, a curable synthetic composition applied by injection moulding around the connecting point 2 is suitable for this. Overall, the electrical junction 3 shown in FIG. 2 is then produced.

Preferably, it is provided for the insulating material 4 to surround the conductors 1, in the region of the conductor ends 1a projecting in exposed manner, in each case in the shape of a substantially cylindrical jacket 4a and for the conductor ends 1b to emerge centrally from the end face 4b thereof.

The three cylindrical jackets 4a may preferably have an annular peripheral groove 5 which makes it possible for the shrink-fit connector described below to have a better grip on the electrical junction 3.

FIG. 3 shows a shrink-fit connector 6 as known per se. This has a central aluminium sleeve 7 which is provided in the middle with protuberances 7a which limit the depth of penetration of the conductor ends 1a on the one hand and that of the conductor end 8 on the other. This aluminium sleeve 7 is surrounded by a shrink-on tube 9 which gets smaller under the action of heat and hence enables sealing with respect to the parts pushed into the shrink-fit connector.

FIG. 3 also shows the further, preferably flexible cable 11, having an electrical conductor 8 and an insulation 10. This cable is to be attached to the electrical junction according to FIG. 2 on site, by means of the shrink-fit connector 6: for this, all that is required is to push the shrink-fit connector 6 according to FIG. 3 in the direction of the arrow, onto the right-hand conductor end 1a projecting in exposed manner and the right-hand cylindrical jacket 4a of the electrical junction 3. Then the cable 11 is pushed in, with the conductor end 8 pushed into the aluminium sleeve 7 as far as the protuberances 7a. Then this aluminium sleeve is pinched to make a firm electrical connection between the conductor end 1a of the electrical junction 3 and the conductor end 8 of the cable 11. Finally, a further action of heat is applied to the shrink-on tube 9, which then comes up in sealing manner against the outside of the jacket 4a of the electrical junction 3, on the one hand, and forms a seal with respect to the insulation 10 of the electrical flexible cable 11, on the other.

FIG. 4 shows the connected position. It is clear from this that the conductor ends 1a and 8 are in electrical and mechanical connection with one another by way of the sleeve 7, while after the action of heat the shrink-on tube 9 comes up snugly against the outer face of the jacket 4a on the one hand and against the outer face of the insulation 10 of the attached electrical cable on the other. This has the result that the flexible cable 11 is attached in a manner protected from environmental influences, in particular moisture and water. It goes without saying that the further exposed conductor ends illustrated in FIG. 4 at the top and on the left may be connected in sealing manner in the same way. Overall, a T-shaped branching of three cables protected from environmental influences is then achieved.

It goes without saying that the invention is not restricted to the example embodiments illustrated. For example, Y-shaped or star-shaped branches may also be made in the same way. Nor is the shape of the electrical junction restricted to the shape illustrated, although the cylindrical outer faces are particularly well suited to the use of conventional shrink-fit connectors. In principle, however, other sealing connection mechanisms may also be provided to connect the electrical junctions to conductors, in particular flexible cables, that are to be attached. The essential point is the basic idea of surrounding the critical connecting point of the conductors to be branched off with an electrically insulating material beforehand and hence sealing them off perfectly from environmental influences. Suitable insulating materials in addition to thermoplastic synthetic materials are also, for example, elastomer materials.

1. An electrical junction having at least three electrical conductors which project in different directions from at least one connecting point, characterised in that, in the region of the connecting point (2), the conductors (1) are surrounded with insulating material (4), with the conductor ends (1a) projecting out of the insulating material (4).

2. An electrical junction according to claim 1, characterised in that the electrical conductors (1) are in particular in the form of rigid wires.

3. An electrical junction according to claim 1, characterised in that the conductors (1) project from the connecting point (2) in a T shape or Y shape.

4. An electrical junction according to claim 1, characterised in that the conductors (1) are embedded in synthetic material in the region of the connecting point (2).

5. An electrical junction according to claim 4, characterised in that the conductors (1) are surrounded on all sides by a curable synthetic composition by injection moulding or encapsulation in the region of the connecting point (2).

6. An electrical junction according to claim 1, characterised in that the insulating material (4) surrounds the conductors (1) in the region of the projecting conductor ends (1a) in each case in the shape of a preferably cylindrical jacket (4a), and a respective conductor end (1a) emerges from the end face (4b) thereof.

7. An electrical junction according to claim 6, characterised in that the jacket has a preferably annular peripheral groove (5).

8. An electrical junction according to claim 1, characterised in that the conductor ends (1a) project from the insulating material (4) to a length of 0.5 to 2 cm.

9. A process for making an electrical junction according to claim 1, characterised in that the insulating material (4) is applied by injection moulding around the connecting point (2).

10. An electrical connection system having an electrical junction according to claim 1, in which further electrical conductors (8) which are surrounded by an insulation (10) may be attached to the electrical junction, with the electrical connecting points at which the further conductors are attached to the projecting conductor ends (1a) of the electrical junction (3) each being surrounded by a sleeve (9) which is sealed on the one hand with respect to the insulating material (4) of the junction (3) and on the other with respect to the insulation (10) of the respective further conductor (8).

11. An electrical connection system according to claim 10, characterised in that the electrical conductors (8) are flexible.

12. An electrical connection system according to claim 10, characterised in that the sleeve (9) is in the form of a shrink-on tube which shrinks under the action of heat.

13. An electrical connection system according to claim 12, characterised in that the shrink-on tube (9) has a shrink-fit connector (7) for electrically connecting a further conductor (8) to a projecting conductor end (1a) of the junction (3).
